(19) United States
(12) Patent Application Publication
(10) Pub. No.: US 2026/0296395 A1
(43) Pub. Date: Oct. 1, 2026

(54) Electromechanical Drum Brake

(71) Applicant: ZF Active Safety GMBH, Koblenz (DE)

(72) Inventor: Volker KNOP, Ulmen (DE)

(21) Appl. No.: 19/635,021

(22) Filed: Mar. 31, 2026

(30) Foreign Application Priority Data
Apr. 1, 2025 (DE) 102025112763.8

(51) Int. Cl. B60T 17/22; B60T 1/06; B60T 13/74; F16D 51/00; F16D 51/22; F16D 65/22; F16D 66/00; F16D 127/02; G01B 7/16

(52) U.S. Cl. CPC B60T 17/22; B60T 1/067; B60T 13/746; F16D 51/22; F16D 65/22; F16D 66/00; G01B 7/18; F16D 2051/003; F16D 2066/005; F16D 2127/02

(57) ABSTRACT

An electromechanical drum brake has a vehicle-mounted brake anchor plate, a wheel-mounted brake drum, a spreader mechanism, which is fastened to the brake anchor plate and is designed to push a leading and a trailing brake shoe of the drum brake away from each other in opposite directions along an active axis and against the brake drum, and a support block, which is fastened to the brake anchor plate, protrudes into the brake drum and forms a first support bearing for the leading brake shoe and a second support bearing for the trailing brake shoe. In this case, the first support bearing and/or the second support bearing are/is formed in each case by a strain-sensitive sensor unit.

### TECHNICAL FIELD

The invention relates to an electromechanical drum brake having a vehicle-mounted brake anchor plate, a wheel-mounted brake drum, a spreader mechanism, which is fastened to the brake anchor plate and is designed to push a leading and a trailing brake shoe of the drum brake away from each other in opposite directions along an active axis and against the brake drum, and a support block, which is fastened to the brake anchor plate, protrudes into the brake drum and forms a first support bearing for the leading brake shoe and a second support bearing for the trailing brake shoe.

### BACKGROUND

Electromechanical drum brakes of this type are known.

Drum brakes are frequently used as service brakes in motor vehicles. In addition, they can provide a parking brake function. In contrast to hydraulically actuated drum brakes, electromechanical drum brakes have the advantages that they act independently of a hydraulic brake system and can be triggered directly by a vehicle electronic system.

It is the object of the invention to provide an electromechanical drum brake by means of which a defined effective braking torque can be ensured.

The object is achieved by an electromechanical drum brake having a vehicle-mounted brake anchor plate, a wheel-mounted brake drum, a spreader mechanism, which is fastened to the brake anchor plate and is designed to push a leading and a trailing brake shoe of the drum brake away from each other in opposite directions along an active axis and against the brake drum, and a support block, which is fastened to the brake anchor plate, protrudes into the brake drum and forms a first support bearing for the leading brake shoe and a second support bearing for the trailing brake shoe. The first support bearing and/or the second support bearing are/is formed in each case by a strain-sensitive sensor unit.

Within the context of the invention, the leading brake shoe is the brake shoe which forms the leading brake shoe when driving in the primary direction of the vehicle or when driving forwards.

The supporting force with which the leading or trailing brake shoe acts on the corresponding support bearing is detected by the assigned strain-sensitive sensor. The supporting force can be used to calculate the effective braking torque on the brake drum under dynamic and static conditions, and it can be ensured on the basis of these data that a defined braking torque is effective. In this way, vehicle stability can be improved, for example by generating virtually the same braking torque on both sides of the vehicle axle. It can also be detected whether the braking torque has been properly reduced after a braking operation or whether an unwanted residual braking torque remains.

According to one aspect, the drum brake is an electromechanically actuated simplex drum brake. The advantage of the simplex drum brake over duplex or servo drum brakes is that it does not react as sensitively to variations in the brake pad friction value, for example due to temperature changes, and therefore does not cause such large fluctuations in braking torque.

In one embodiment, the sensor unit has an expansion membrane, which forms the corresponding support bearing. The supporting force with which the associated brake shoe acts on the corresponding support bearing leads to elastic deformation and consequently to a specific surface expansion of the expansion membrane, which is detected by the strain-sensitive sensor.

In this case, the expansion membrane can be disc-shaped and, with a circular-cylindrical centring portion, can be centred in a recess of the support block and, with an annular contact surface, can extensively and axially abut an end face of the support block. This design makes particularly high quality of detection of the supporting force possible.

Furthermore, it can be provided that the cylinder axes of the centring portion and of the recess run parallel to the active axis of the spreader mechanism, and a plane, in which the contact surface of the expansion membrane and the end face of the support block extend, extends perpendicular to the active axis of the spreader mechanism. This further improves the quality with which the supporting force is detected.

In addition or alternatively, the expansion membrane can be formed rotationally symmetrically to the cylinder axis of the centring portion. This symmetrical design has the advantage that the surface of the expansion membrane is correspondingly symmetrically elastically deformed and thus the expansion thereof can be particularly precisely detected.

In a further embodiment, the sensor unit has a plurality of strain-sensitive sensors, which are part of a Wheatstone measuring bridge. In this way, the expansion of the expansion membrane and thus the supporting force acting on the expansion membrane can be particularly effectively determined.

In this case, the strain-sensitive sensors can be fastened or coupled to an inner side of the expansion membrane facing away from the assigned brake shoe. As a result, the strain-sensitive sensors are arranged at a location that, on the one hand, is protected and at which, on the other hand, the surface expansion of the expansion membrane can be effectively detected.

Furthermore, the strain-sensitive sensors can be designed as metal foil strain gauges, by means of thin-film technology or as semiconductor strain gauges, which are based on the piezoresistive effect, and can therefore be particularly efficient and compact.

In one embodiment, the sensor unit has a printed circuit board, which is fastened to the expansion membrane via an insulating disc. In this way, the printed circuit board is mounted on the expansion membrane in a thermally protected manner.

According to one aspect, the expansion membrane is fastened with a form fit, and therefore effectively, to a basic body of the support block by means of a fastening sleeve.

In another embodiment, in which the first support bearing is formed by a first strain-sensitive sensor unit and the second support bearing by a second strain-sensitive sensor unit, the expansion membranes of the two support bearings are mounted on opposite sides of the basic body and electronic components are accommodated in the interior of the basic body. In this way, the support block is particularly compact and robust.

A tension spring connecting the two brake shoes can run radially outside the support bearings here. The brake shoes are pulled towards the support block by the tension spring, as a result of which a defined position of the brake shoes is always ensured and residual braking torques are reliably avoided.

Furthermore, it can be provided that the support bearings are positioned at that end of the associated brake shoes which is opposite the end associated with the spreader mechanism. The existing installation space is therefore used efficiently.

In addition, the support bearings may lie between the ends of the brake shoes, which are arranged opposite the ends associated with the spreader mechanism, and between end faces of the brake shoes. The end faces contact the support bearings. In this way, the drum brake is particularly compact and effective.

### BRIEF DESCRIPTION OF THE DRAWINGS

Further advantages and features emerge from the description below and from the attached drawings, in which:

shows, in a perspective illustration, a drum brake according to the invention with a support block,

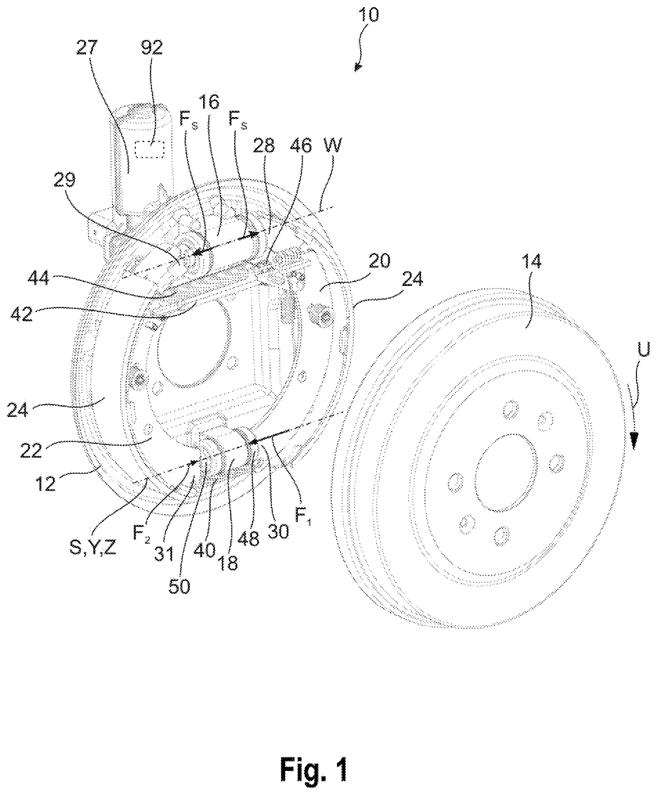

shows, in a sectional view, the support block from FIG. 1,

shows, in an exploded illustration, the support block from FIG. 1,

shows, in an exploded illustration, a strain-sensitive sensor unit of the support block from FIG. 1, and shows, in a schematic diagram, a Wheatstone measuring bridge.

### DESCRIPTION

The following detailed description in conjunction with the accompanying drawings, in which the same numbers refer to the same elements, is intended to describe different embodiments of the disclosed subject matter and is not intended to represent the only embodiments. Each embodiment described in this disclosure is only an example or for illustrative purposes and should not be interpreted as preferred or advantageous compared with other embodiments.

All the features disclosed below with reference to the exemplary embodiments and/or the accompanying figures can be combined on their own or in any subcombination with features of the aspects of the present disclosure, including features of preferred embodiments, provided that the resulting combination of features is meaningful to a person skilled in the art.

FIG. 1 shows an electromechanical drum brake 10 for a motor vehicle, which has a vehicle-mounted brake anchor plate 12 and a wheel-mounted brake drum 14.

The drum brake 10 is, for example, an electromechanically actuated simplex drum brake.

The brake anchor plate 12 is fixedly mounted on the motor vehicle in a manner secured against rotation, for example on a torsion-proof vehicle axle of the motor vehicle.

The brake drum 14, on the other hand, is fixedly connected to a wheel of the motor vehicle, for example via the hub of the wheel, and is thus mounted rotatably with respect to the brake anchor plate 12 in and counter to the circumferential direction U.

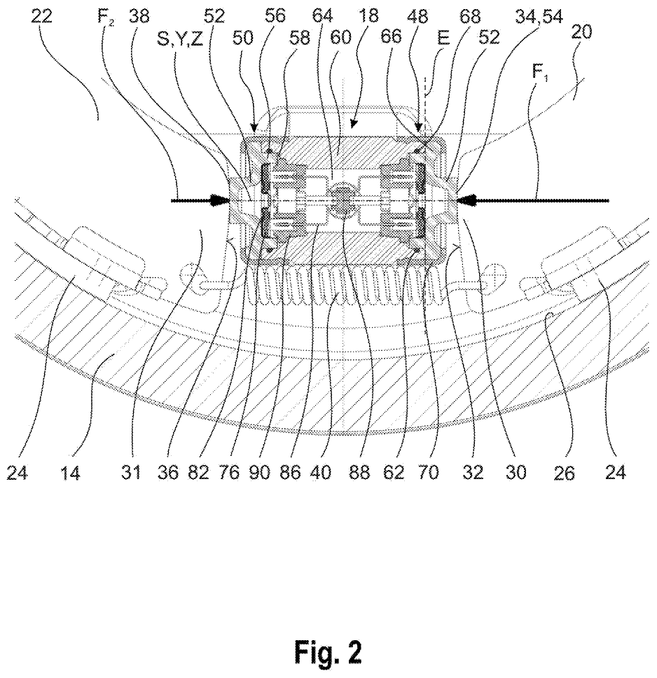

The drum brake 10 furthermore has a spreader mechanism 16 and a support block 18, which are each fastened to the brake anchor plate 12 and protrude into the brake drum 14, and a leading brake shoe 20 and a trailing brake shoe 22 with friction pads 24, which are arranged opposite a friction surface 26 (see FIG. 2) on the inside of the brake drum 14.

The brake shoes 20, 22 are designed, for example, as sliding shoes and therefore have no fixed bearing or no fixed pivot point.

In the present embodiment, the leading and the trailing brake shoe 20, 22 are designed analogously, for example mirror-symmetrically, to each other.

To actuate the spreader mechanism 16, the drum brake 10 has an actuator 27, which is arranged rearwards with respect to the brake anchor plate 12, i.e. opposite the brake drum 14.

The spreader mechanism 16 is designed to push the leading and trailing brake shoe 20, 22 away from each other in opposite directions along an active axis W (see FIG. 1) and against the friction surface 26.

For this purpose, the spreader mechanism 16 is arranged between two first ends 28, 29 of the brake shoes 20, 22, on which the spreader mechanism 16 acts.

Furthermore, the brake shoes 20, 22 abut against the support block 18 via second ends 30, 31 which are arranged opposite the first ends 28, 29 in the circumferential direction U.

The leading brake shoe 20 abuts here against a first support bearing 34 of the support block 18 by means of an end face 32 (see FIG. 2) of the second end 30, whereas the trailing brake shoe 22 abuts against a second support bearing 38 of the support block 18, which is arranged opposite the first support bearing 34, by means of an end face 36 of the second end 31.

The brake shoes 20, 22 are pulled by a first tension spring 40 towards the support block 18, which is arranged, for example, radially outside the support block 18 and connects the second ends 30, 31 to each other.

At the opposite end, the brake shoes 20, 22 are held at a defined distance by a pressure sleeve 42 (see FIG. 1) and pulled towards the spreader mechanism 16 by a second tension spring 44.

For example, an automatic friction pad wear adjuster is integrated in the pressure sleeve 42, which keeps the clearance between the brake shoes 20, 22 and the brake drum 14 virtually constant under wear conditions. The distance between the brake shoes 20, 22 is adjusted depending on wear using an adjusting screw 46.

In order to generate a braking torque on the wheel to which the drum brake 10 is assigned, the friction pads 24 of the two oppositely acting brake shoes 20, 22 are pressed by means of the spreader mechanism 16 with a spreading force F_{S} against the internal friction surface 26 of the brake drum 14. In each case, a clearance present between the brake shoes 20, 22 and the brake drum 14 in the unactuated position is overcome. The necessary spreading force and the necessary actuating stroke are generated by the bilaterally acting spreader mechanism 16.

The spreading force F_{S} exerted on the two brake shoes 20, 22 is substantially identical in magnitude but acting in an opposite direction for each brake shoe 20, 22.

The brake shoes 20, 22 are supported at their second ends 30, 31 on the fixed support block 18 and in each case upon actuation of the spreader mechanism 16 exert oppositely acting support forces F₁, F₂ on the support block 18.

In this way, a frictional torque is created on the brake drum 14, with which the rotational movement of the brake drum 14 is delayed or prevented depending on the situation.

Owing to the fact that the brake drum 14 is coupled via the rim to the tyre of the wheel and the tyre is in contact with the road surface, a situation-dependent braking torque is generated with which the motor vehicle is decelerated or kept in the inoperative position.

If the motor vehicle is statically motionless on the horizontal, it is not possible to distinguish between the leading and the trailing brake shoe 20, 22, since the brake drum 14 is not set in this case into a rotational movement because there is no downhill slope force here. The magnitudes of the supporting forces F₁, F₂ are identical in this case. If the motor vehicle is braked dynamically or is statically parked on a slope, then the exerted support force F₁ of the leading brake shoe 20 is many times greater than the exerted support force F₂ of the trailing brake shoe 22. This fact is shown in FIG. 2 by the different length of the arrows, which indicate the supporting forces F₁, F₂.

In order to detect the acting supporting forces F₁, F₂, the first support bearing 34 is formed by a first strain-sensitive sensor unit 48 and the second support bearing 38 by a second strain-sensitive sensor unit 50.

In an alternative embodiment, the support block 18 may comprise only one of the two sensor units 48, 50, so that, correspondingly, only the supporting force F₁ of the leading brake shoe 20 or the supporting force F₂ of the trailing brake shoe 22 can be detected.

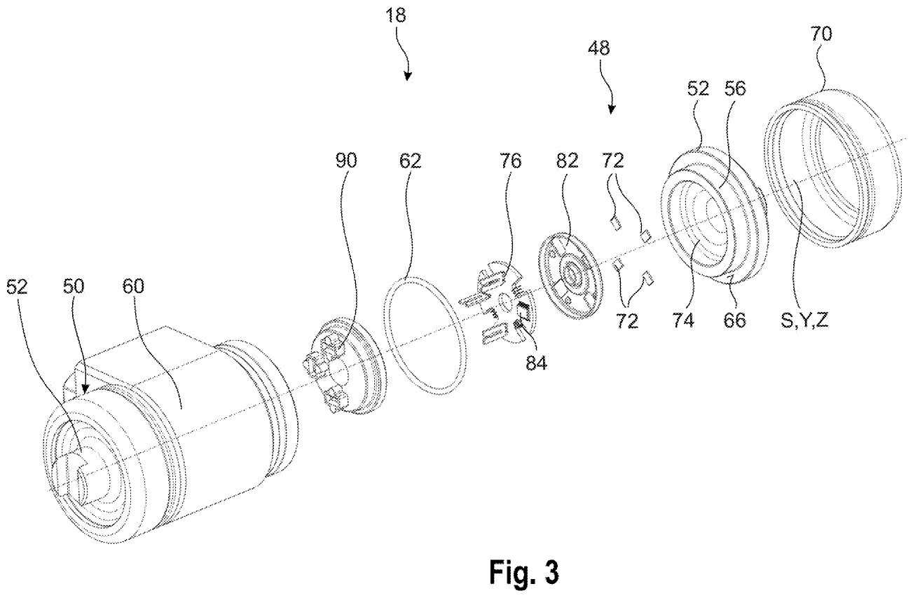

In the present embodiment, the second strain-sensitive sensor unit 50 is designed in the same way as the first strain-sensitive sensor unit 48. With reference to FIGS. 2 to 5, the structure of the sensor units 48, 50 is therefore described by way of example below with reference to the first strain-sensitive sensor unit 48. For reasons of clarity, in FIG. 2, some of the features of the first strain-sensitive sensor unit 48 are marked with reference signs at corresponding locations of the second strain-sensitive sensor unit 50.

The sensor unit 48 (see FIG. 2) has an expansion membrane 52 with a central contact zone 54, which forms the first support bearing 34 for the leading brake shoe 20.

The expansion membrane 52 is rotationally symmetrical with respect to an axis of symmetry S and is in the shape of a disc.

In the present embodiment, the expansion membrane 52 is formed from an elastic material, for example a high-strength steel.

Axially opposite the contact zone 54, the expansion membrane 52 has a circular-cylindrical centring portion 56, which is received in a stepped cylindrical recess 58 in a basic body 60 of the support block 18.

The recess 58 is designed in a complementary manner to the centring portion 56, so that the cylinder axis Y of the centring portion 56 coincides with the cylinder axis Z of the recess 58 and thus the centring portion 56 is centred in the recess 58.

The cylinder axis Y of the centring portion 56 furthermore coincides with the axis of symmetry S of the expansion membrane 52.

An annular seal 62 which seals a chamber 64 in the interior of the basic body 60 is arranged between the centring portion 56 and the basic body 60.

The expansion membrane 52 furthermore has a radially outwardly arranged annular contact surface 66, via which the expansion membrane 52 abuts against an annular end face 68 of the basic body 60 extensively in the axial direction and is supported on the basic body 60 in the direction of the supporting force F₁.

In this connection, the cylinder axes Y, Z of the centring portion 56 and the recess 58 extend parallel to the active axis W (see FIG. 1) of the spreader mechanism 16.

Furthermore, the contact surface 66 of the expansion membrane 52 and the end face 68 of the basic body 60 extend in a plane E (see FIG. 2), which extends perpendicular to the cylinder axes Y, Z.

The expansion membrane 52 is fastened with a form fit to the basic body 60 by means of a fastening sleeve 70.

The fastening sleeve 70 is centred on the basic body 60 and is fixedly connected to the basic body 60 by crimping, for example.

In the embodiment shown, the contact zone 54 protrudes axially in relation to the fastening sleeve 70 (see FIG. 2), as a result of which the end face 32 of the leading brake shoe 20 abuts against the contact zone 54 at an axial spacing from the fastening sleeve 70. This ensures that the leading brake shoe 20 does not come into contact with the fastening sleeve 70, regardless of how much the expansion membrane 52 is elastically deformed during operation.

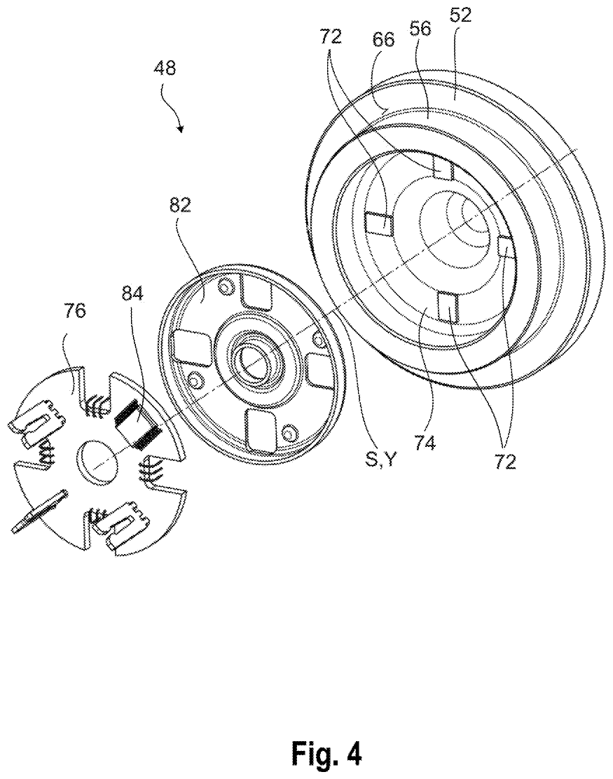

In order to detect the supporting force F₁ acting on the expansion membrane 52, the sensor unit 48 has a plurality of strain-sensitive sensors 72 (see FIG. 4), which are mounted on the inner side 74 of the expansion membrane 52 opposite the leading brake shoe 20 and radially within the centring portion 56.

For example, the sensor unit 48 has four strain-sensitive sensors 72.

In the present embodiment, the strain-sensitive sensors 72 are arranged on the surface of the expansion membrane 52 in the transition region between the contact zone 54 and the contact surface 66.

In all of the embodiments, the strain-sensitive sensors 72 are connected or coupled to the expansion membrane 52 in such a way that strain deformations of the expansion membrane 52 are transmitted to the strain-sensitive sensors 72 and are thus detected by them.

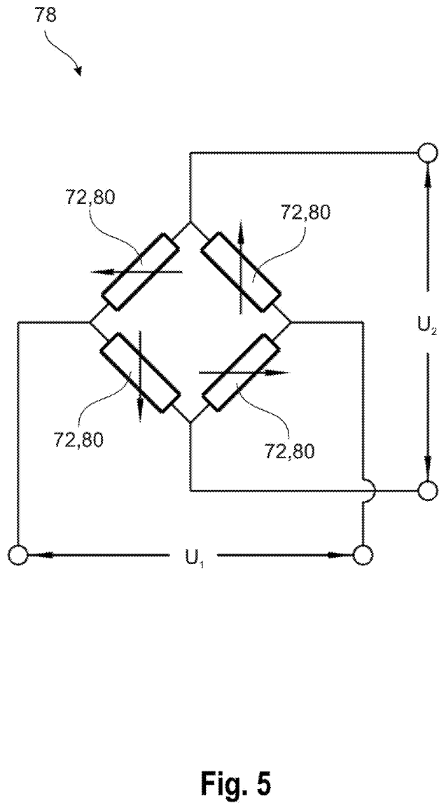

The strain-sensitive sensors 72 are signal-transmittingly connected to a printed circuit board 76 of the sensor unit 48 and are part of a Wheatstone measuring bridge 78 (see FIG. 5).

In one embodiment, the strain-sensitive sensors 72 are formed by metal foil strain gauges (DMS), which are connected to form a Wheatstone half or full measuring bridge. The measuring grid of the metal foil strain gauge has a strain-dependent measuring resistance. The measuring bridge 78 compensates for temperature expansions.

In an alternative embodiment, the strain-sensitive sensors 72 are manufactured using thin-film technology. In this case, a thin, strain-sensitive, electrically conductive, meandering metal layer consisting, for example, of an NiCr precision resistance alloy is applied to the inner side 74 of the expansion membrane 52. The meandering metal coating is segmentally connected and oriented to form a temperature-compensating Wheatstone half or full measuring bridge. The meandering metal coating has a strain-dependent measuring resistance.

In another embodiment, the strain-sensitive sensors 72 are constructed from semiconductor strain gauges based on the piezoresistive effect. The specific resistance of the semiconductor changes under mechanical strain. The semiconductor strain gauges are connected to a temperature-compensating Wheatstone half or full measuring bridge.

The measuring bridge 78 is supplied here with a constant supply voltage U₁. The strain deformations of the expansion membrane 52 cause a proportional change in the resistors 80 of the measuring bridge 78. As a result, the resistance-dependent signal voltage U₂ of the measuring bridge 78 is proportional to the strain deformation of the expansion membrane 52.

In this connection, a temperature sensor can be provided on the expansion membrane 52.

The strip conductors for the measuring bridge 78 are part of the printed circuit board 76.

Via the printed circuit board 76, the measuring bridge 78 is supplied with the supply voltage U₁ and the resistance-dependent analogue signal voltage U₂ of the measuring bridge 78 is tapped off.

In order to protect the printed circuit board 76 from the high temperatures that the brake shoes 20, 22 may have during the operation of the drum brake 10, the printed circuit board 76 is fastened to the expansion membrane 52 via an insulating disc 82 (see FIG. 4), for example in a manner centred with respect to the cylinder axis Y.

Furthermore, a temperature sensor (not shown) can be provided on the expansion membrane 52, which is signal-transmittingly connected to the printed circuit board 76.

The printed circuit board 76 furthermore comprises an electronic evaluation chip 84 with an application-specific integrated circuit (ASIC).

Depending on the embodiment, in the evaluation chip 84 there is integrated an analogue signal amplifier for the resistance-dependent signal voltage of the measuring bridge 78 or an analogue-to-digital converter, which converts the analogue resistance-dependent signal voltage of the measuring bridge 78 into a digital signal voltage, for example according to a Single Edge Nibble Transmission (SENT) data protocol.

The printed circuit board 76 is connected by means of busbars 86 (see FIG. 2) via a plug terminal 88 to electrical contacts of a plug (not shown).

The busbars 86 are aligned and supported by a support disc 90 made of plastic.

The plug is located at the rear of the brake anchor plate 12 and protrudes from the basic body 60.

In the present embodiment, the plug has electrical contacts for external contact connection of the constant supply voltage U₁ and the analogue or digital signal voltage U₂. Via the external contact connection, the analogue or digital signal voltage U₂ is transmitted to a control unit 92 of the drum brake 10, which is arranged, for example, in the actuator 27.

In addition or alternatively, the printed circuit board 76 may have an electronic transmitter and an antenna for wireless data transmission. In this case, the data signal of the measuring bridge 78 is transmitted wirelessly to the control unit 92 and the plug has only the electrical contacts for the constant supply voltage U₁.

The expansion membranes 52 and the basic body 60 here form a housing for the electronic components, such as the printed circuit board 76 and the busbars 86, which are thus arranged protected in the chamber 64 in the interior of the basic body 60.

During operation, when the drum brake 10 is actuated, the leading brake shoe 20 exerts the supporting force F₁ directly on the expansion membrane 52.

The supporting force F₁ has the character of a compressive force and acts parallel to the spreading force F_{S}.

The expansion membrane 52 is designed in such a way that it is elastically deformed by the action of the supporting force F₁, comparably to a disc spring. The resulting strain deformations on the surface of the expansion membrane 52 are proportional to the effective supporting force F₁ and are detected by the strain-sensitive sensors 72. The supporting force F₁ is determined by the control unit 92 using the measuring bridge 78.

In an analogous manner, the supporting force F₂ can be detected with the second sensor unit 50, with which the trailing brake shoe 22 acts on the expansion membrane 52 of the second sensor unit 50.

In embodiments in which the drum brake 10 has only one of the two sensor units 48, 50, the opposite side of the basic body 60 is closed, for example by a cover or a wall, which is formed integrally with the basic body 60.

In this way, a drum brake 10 is provided, by means of which a defined effective braking torque can be ensured on the basis of the determined supporting force F₁ and/or supporting force F₂.

1. Electromechanical drum brake (10) having a vehicle-mounted brake anchor plate (12), a wheel-mounted brake drum (14), a spreader mechanism (16), which is fastened to the brake anchor plate (12) and is designed to push a leading and a trailing brake shoe (20, 22) of the drum brake (10) away from each other in opposite directions along an active axis (W) and against the brake drum (14), and a support block (18), which is fastened to the brake anchor plate (12), protrudes into the brake drum (14) and forms a first support bearing (34) for the leading brake shoe (20) and a second support bearing (38) for the trailing brake shoe (22), wherein the first support bearing (34) and/or the second support bearing (38) are/is formed in each case by a strain-sensitive sensor unit (48, 50).

2. Drum brake (10) according to claim 1, wherein the sensor unit (48, 50) has an expansion membrane (52), which forms the corresponding support bearing (34, 38).

3. Drum brake (10) according to claim 2, wherein the expansion membrane (52) is disc-shaped and, with a circular-cylindrical centring portion (56), is centred in a recess (58) of the support block (18) and, with an annular contact surface (66), extensively and axially abuts an end face (68) of the support block (18).

4. Drum brake (10) according to claim 3, wherein the cylinder axes (Y, Z) of the centring portion (56) and of the recess (58) run parallel to the active axis (W) of the spreader mechanism (16), and a plane (E), in which the contact surface (66) of the expansion membrane (52) and the end face (68) of the support block (18) extend, extends perpendicular to the active axis (W) of the spreader mechanism (16).

5. Drum brake (10) according to claim 3, wherein the expansion membrane (52) is formed rotationally symmetrically to the cylinder axis (Y) of the centring portion (56).

6. Drum brake (10) according to claim 2, wherein the sensor unit (48, 50) has a plurality of strain-sensitive sensors (72), which are part of a Wheatstone measuring bridge (78).

7. Drum brake (10) according to claim 6, wherein the strain-sensitive sensors (72) are fastened or coupled to an inner side (74) of the expansion membrane (52) facing away from the assigned brake shoe (20, 22).

8. Drum brake (10) according to claim 6, wherein the strain-sensitive sensors (72) are designed as metal foil strain gauges, by means of thin-film technology or as semiconductor strain gauges, which are based on the piezoresistive effect.

9. Drum brake (10) according to claim 2, wherein the sensor unit (48, 50) has a printed circuit board (76), which is fastened to the expansion membrane (52) via an insulating disc (82).

10. Drum brake (10) according to claim 2, wherein the expansion membrane (52) is fastened with a form fit to a basic body (60) of the support block (18) by means of a fastening sleeve (70).

11. Drum brake (10) according to claim 10, wherein the first support bearing (34) is formed by a first strain-sensitive sensor unit (48) and the second support bearing (38) by a second strain-sensitive sensor unit (50), wherein the expansion membranes (52) of the two support bearings (34, 38) are mounted on opposite sides of the basic body (60) and electronic components (76, 86) are accommodated in the interior of the basic body (60).

12. Drum brake (10) according to claim 11, wherein a tension spring (40) connecting the two brake shoes (20, 22) runs radially outside the support bearings (34, 38).

13. Drum brake (10) according to claim 1, wherein the support bearings (34, 38) are positioned at that end (30,

31) of the associated brake shoes (20, 22) which is opposite the end (28, 29) associated with the spreader mechanism (16).

14. Drum brake (10) according to claim 13, wherein the support bearings (34, 38) lie between the ends (30, 31) of the brake shoes (20, 22), which are arranged opposite the ends (28, 29) associated with the spreader mechanism (16), and between end faces (32, 36) of the brake shoes (20, 22), the end faces (32, 36) contacting the support bearings (34, 38).
